(19) United States
(12) Patent Application Publication
(10) Pub. No.: US 2003/0009044 A1
(43) Pub. Date: Jan. 9, 2003

(54) Novel aminosilyl borylalkanes, their production and use

(76) Inventor: Hardy Jungermann, Santa Barbara, CA (US)

Correspondence Address: BAYER CORPORATION, PATENT DEPARTMENT, 100 BAYER ROAD, PITTSBURGH, PA, 15205, US

(21) Appl. No.: 10/181,739

(22) PCT Filed: Jan. 11, 2001
(86) PCT No.: PCT/EP01/00299

(30) Foreign Application Priority Data
Jan. 24, 2000 (DE) 100028764

(51) Int. Cl. C07F 7/12

(52) U.S. Cl. 556/402

(57) ABSTRACT

The present invention relates to novel aminosilylborylalkanes, to a process for their preparation from the corresponding chlorine compounds, to coated substrates produced using aminosilylborylalkanes of this type, and to a process for the production of ceramic protective layers.

The present invention relates to novel aminosilylborylalkanes, to a process for their preparation from the corresponding chlorine compounds, to coated substrates produced using aminosilylborylalkanes of this type, and to a process for the production of ceramic protective layers.

In order to protect high-temperature components against oxidation, it is known to provide the component with a quartz (SiO²) layer by chemical vapor deposition (CVD) using silanes. At a temperature above about 1100° C., the amorphous quartz layer is converted into the crystalline state (cristobalite). This so-called quartz transition results in cracks in the coating, which lead to rapid oxidation of the component, in particular after cooling and re-heating of the component, i.e. under thermal cycling stresses.

Although crack formation can be suppressed by further layers, for example silicon carbide layers, the application of such a sequence of different layers is, however, associated with a correspondingly large number of process steps and is thus expensive and time-consuming. In addition, a quartz layer applied to a metal substrate by CVD results in flaking-off under mechanical stresses and thermal cycling stresses.

GB Patent 792,274 discloses the deposition of silicon-containing layers by the CVD process from a carbon-, boron- and silicon-containing gas stream at from 1000° C. to 1400° C. onto, for example, ceramic substrates with formation of Si—B—C layers. The starting materials used are alkylsilanes and alkylboranes.

WO 98/10118 describes the deposition of silicon-containing layers by the CVD process at from 400° C. to 1800° C. onto, for example, metal substrates with formation of Si—B—C—N layers. The starting materials used are aminosilylborylamines.

However, the silicon-containing coatings described in the prior art are not suitable for high-temperature applications above from 1400° C. to 1800° C.

There was thus a demand for compounds which enable substrates of different types to be provided in a simple manner with a strongly adherent protective layer which protects the substrates during high-temperature applications.

Surprisingly, aminosilylborylalkanes have now been found which can be applied to a substrate in a simple manner by CVD and protect this substrate during high-temperature applications.

The aminosilylborylalkanes according to the invention are those of the formula (I)

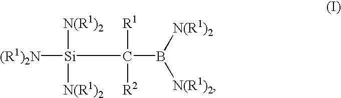

in which

R¹ is an alkyl group having from 1 to 4 carbon atoms or phenyl, and

R² is hydrogen, an alkyl group having from 1 to 4 carbon atoms or phenyl.

Examples of an alkyl group having from 1 to 4 carbon atoms are methyl, ethyl, propyl, isopropyl, sec-butyl or tert-butyl.

R¹ is preferably methyl, and R² is preferably hydrogen.

The compounds of the formula (I) can be prepared in accordance with the invention by reaction of compounds of the formula (II)

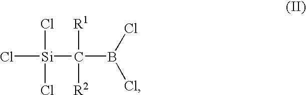

with dialkylamines or diphenylamine in an inert organic solvent. The reaction is preferably carried out with compounds of the formula (II) in which R¹ is methyl and R² is hydrogen. The dialkylamine employed is preferably dimethylamine. Inert organic solvents which can be employed are, for example, alkanes, aromatic hydrocarbons or ethers. Preference is given to C₅-C₈-alkanes and toluene, particularly preferably n-hexane. It is also possible to employ inert organic solvent mixtures.

A compound of the formula (II) in which R¹ is methyl and R² is hydrogen is particularly preferably reacted with dimethylamine in n-hexane.

The compounds of the formula (II) and the amine are preferably employed in a molar ratio of from 1:1 to 1:20, preferably from 1:2 to 1:10, particularly preferably from 1:2.5 to 1:5.

The reaction temperature can vary between −100° C. and 20° C., and is preferably from 80° C. to −30° C., particularly preferably from −70° C. to −40° C.

The preparation of the compounds of the formula (II) is described in German Patent 19 713 766.

In order to carry out the reaction, the compounds of the formula (II) can be initially introduced in an inert organic solvent, and the amine can be added dropwise. The reaction mixture here is preferably stirred. After completion of the reaction, the reaction batch can be filtered and washed. The filtrate, which contains the reaction product, can, for work-up, be evaporated and distilled.

The compounds of the formula (I) according to the invention can be used for application of protective layers to substrates. These protective layers are produced in accordance with the invention using compounds of the formula (I) in a CVD process. Particular preference is given for this purpose to compounds of the formula (I) in which R¹ is methyl and R² is hydrogen.

The CVD process used is preferably a thermal CVD process, in particular an LPCVD (low pressure CVD) process. However, it is also possible in accordance with the invention to employ other CVD process, in particular plasma CVD, instead of the thermal CVD process.

The apparatus in which the thermal CVD process can be carried out preferably has a pressure-tight stock tank which contains the liquid starting compound of the formula (I), preferably the liquid starting compound of the formula (I) in which R¹ is methyl and R² is hydrogen, and is pressurized by an inert gas, for example argon. The liquid starting compound can be fed via a flow meter to a mixing device into which an inert gas, for example nitrogen, flows at the same time via a corresponding gas flow meter. An aerosol is thereby formed in the mixing device from the liquid starting compound and evaporates in a heated evaporator without leaving a residue. The vapor is fed to one end of the preferably tubular coating oven, in which the substrate or substrates to be coated are arranged one above the other and/or one behind the other. A vacuum pump is preferably connected to the other end of the tubular oven.

If the starting compound employed is a compound of the formula (I) in which R¹ is methyl and R² is hydrogen, the temperature of the evaporator is preferably from 30° C. to 100° C., particularly preferably from 50° C. to 90° C., very particularly preferably from 60° C. to 80° C.

The pressure in the coating oven is preferably from 10⁻¹ to 10⁻⁵ mbar, particularly preferably from 10⁻² to 10⁻³ mbar.

In the coating oven, the substrate is preferably heated to a temperature of from 400° C. to 1800° C., particularly preferably from 650° C. to 1500° C.

The CVD device described enables the deposition conditions to be maintained precisely and thus enables layers having reproducible properties to be obtained. The layers produced by the process according to the invention contain the elements (where this term also includes bonds to one another) silicon, nitrogen, boron and carbon. Besides these elements, the layer may contain organic residues formed from the starting compounds. These organic residues may affect the properties of the layer. In order to avoid organic residues, the substrate can be coated at an appropriately high temperature. However, the coating can also be carried out at a rather low temperature of the substrate and any organic residues can be removed by thermal aftertreatment in an oven at from 600° C. to 1800° C.

Due to the use of the compounds of the formula (I), the layers produced in accordance with the invention have a comparatively high carbon content. Consequently, in contrast to lower carbon contents, crystallization generally only occurs in the layer at temperatures above 2000° C., which makes these layers particularly suitable for high-temperature applications.

The layers according to the invention are particularly suitable for the protection of metal, carbon and ceramic substrates.

If the layers according to the invention are applied to metal substrates, for example made of steel or a titanium alloy, they are distinguished by high adhesive strength. This turns out particularly well if the metal substrate is coated in the unpolished state, i.e. has a roughness of greater than 5 μm. Besides high adhesive strength, the layers according to the invention also have high wear strength and lubrication properties. The latter can be influenced by the proportion of organic residues emanating from the alkyl or phenyl groups of the starting substrate.

Owing to the excellent tribological properties of the layers according to the invention, the process according to the invention can be employed, for example, for coating metal parts in engine building.

If the substrates coated by the process according to the invention are heated to temperatures of, for example, from 900° C. to 1800° C., in particular from 1200° C. to 1600° C., in an oxygen-containing atmosphere, i.e., for example, in air, the silicon at the surface of the protective layer is oxidized to SiO₂.

This oxidation can be carried out by aftertreatment of the coated substrate in an oven, preferably at from 600° C. to 1 800° C., or during use of the substrate in air at high temperatures. The SiO₂ formed at the surface of the substrate has a relatively low melting point due to the presence of boron. This has the consequence that the protective layer melts in the surface region even at relatively low temperature, and the melt closes any cracks formed in the underlying region of the protective layer, preventing the penetration of oxygen into the substrate.

The process according to the invention produces a protective layer which generally protects the coated substrate reliably against oxidation, even under thermal cycling stresses up to about 2000° C.

The following examples serve to illustrate the invention without representing a limitation.

### EXAMPLES

### Example 1

Preparation of 1-tris(dimethylamino)silyl-1-bis(dimethylamino)borylethane

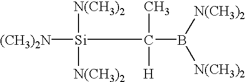

350 ml of dimethylamine were condensed into a 1 l round-bottomed flask at −65° C. 68 g of 1-trichlorosilyl-1-dichloroborylethane

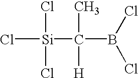

were mixed with 340 ml of absolute n-hexane and added dropwise to dimethylamine over a period of 70 minutes. During this, the flask contents warmed to −58° C., and a white precipitate of dimethylamine hydrochloride deposited. The reaction mixture was stirred for a further 12 hours and then slowly warmed to a temperature of 20° C. The precipitate was filtered off using a reverse frit and washed with n-hexane. The filtrate was evaporated at 80° C. in a rotary evaporator and subsequently distilled under reduced pressure. The main fraction had a boiling point of from 69° C. to 72° C. at 0.2 mbar. The yield was about 80%.

### Example 2

The coating experiments were carried out using graphite tubes having an edge length of 1 cm which were positioned in the center of a tubular oven. Before the coating, the tubes were degreased and dried by heating at 150° C. The graphite tubes were heated to 900° C. in the coating oven in the presence of argon. When the experiment temperature had been reached, 1.5 ml of the starting compound from Example 1 were introduced into a stock vessel, and the entire coating apparatus was evacuated to 5.7·10⁻² mbar. After the pressure had been adjusted, the stock vessel was heated to 65° C. The pressure in the coating apparatus rose to 7.5·10⁻² mbar in the process. After 10 hours, the starting compound had evaporated, and the oven was cooled to 20° C. The coated graphite tubes were subsequently pyrolyzed for 1 hour at 1450° C. under an argon atmosphere. The coatings covered the substrates uniformly, with x-ray electron and transmission electron photomicrographs showing the intimate bond between the substrate and the ceramic coating. The ceramic coating is amorphous. Energy dispersive x-ray analysis showed that the layer contained silicon, boron and carbon and nitrogen.

1. A compound of the formula (I) 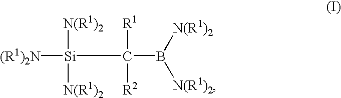
in which
R¹ an alkyl group having from 1 to 4 carbon atoms or phenyl, and
R² is hydrogen or an alkyl group having from 1 to 4 carbon atoms or phenyl.

2. A compound as claimed in claim 1, in which R¹ is methyl and R² is hydrogen.

3. A process for the preparation of compounds as claimed in claim 1 and 2, characterized in that compounds of the formula (II) 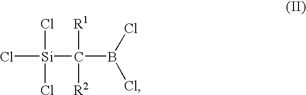
are reacted with dialkylamines or diphenylamine in an inert organic solvent.

4. A process as claimed in claim 3, characterized in that a compound of the formula (II) in which R¹ is methyl and R² is hydrogen is reacted with dimethylamine.

5. A process as claimed in one or more of the preceding claims 3 and 4, characterized in that an inert organic solvent from the group consisting of alkanes, aromatic hydrocarbons or ethers is employed.

6. Uses of compounds as claimed in claim 1 for the production of ceramic protective layers.

7. A process for the production of ceramic protective layers on substrates by chemical vapor deposition (CVD), characterized in that the starting compound employed is a compound as claimed in claim 1.

8. A process as claimed in claim 7, characterized in that the starting compound employed is a compound as claimed in claim 2.

9. A process as claimed in claim 7 or 8, characterized in that the chemical vapor deposition is carried out by low pressure thermal vapor deposition (LPCVD).

10. A process as claimed in claim 9, characterized in that the pressure is from 10⁻¹ to 10⁻⁵ mbar.

11. A process as claimed in one or more of the preceding claims 7 to 10, characterized in that the substrate is heated to a temperature of from 400° C. to 1800° C. during the coating.

12. A process as claimed in one or more of the preceding claims 7 to 11, characterized in that the substrate is subjected to thermal aftertreatment at from 600° C. to 1800° C. after the coating.

13. A process as claimed in claim 12, characterized in that the substrate is exposed to an oxygen-containing atmosphere during the aftertreatment.

14. A process as claimed in one or more of the preceding claims 7 to 13, characterized in that the substrate employed is a metal, carbon or ceramic substrate.

15. A coated substrate obtainable by a process as claimed in one or more of the preceding claims 7 to 14.
